(19) United States
(12) Patent Application Publication
(10) Pub. No.: US 2024/0202645 A1
(43) Pub. Date: Jun. 20, 2024

(54) SYSTEM FOR DETECTING COUNTERFEIT PRODUCTS

(71) Applicant: Countercheck GmbH, Berlin (DE)

(72) Inventors: Fatih UNVER, Berlin (DE); Philip HAMILTON, Berlin (DE)

(21) Appl. No.: 18/555,299

(22) PCT Filed: Apr. 8, 2022
(86) PCT No.: PCT/EP2022/059467

§ 371 Date: Oct. 13, 2023

(30) Foreign Application Priority Data
Apr. 16, 2021 (EP) 21168946.8

(51) Int. Cl. G06Q 10/083; G06V 10/74; G06V 30/10

(52) U.S. Cl. CPC G06Q 10/083; G06V 10/74; G06V 30/10

(57) ABSTRACT

The invention relates to a method for detecting a package containing a counterfeit product, preferably in an associated package sortation facility, wherein the method comprises the steps of providing at least one counterfeit database (110, 111, 11) comprising information of previously found counterfeit packages, providing data of information of at least one package (101), preferably visible information, the information being at least one of text data and/or image data, uploading and storing the provided data, preferably text and/or image, to the counterfeit database (110, 111, 112), comparing the provided data of the package to data already stored in the counterfeit database and search for matches, detecting exact data matches or high similarity data matches, if any exact matches or high similarity matches; determine the possibility, preferably in %, of the package being a counterfeit package by using a counterfeit comparison algorithm.

### FIELD OF THE INVENTION

The present invention relates to a method for detecting a package containing a counterfeit product or an illegal product, preferably in a package sortation facility. Specifically, the invention relates to a method using a database, preferably connected to virtual machine, and a counterfeit algorithm for detecting a package containing a counterfeit product or an illegal product. Further, the present invention relates to a system and a computer program for detecting a package containing a counterfeit or an illegal product.

### BACKGROUND OF THE INVENTION

Today's sorting facilities are not appropriate or optimized for detecting a package potentially containing a counterfeit or illegal product. Often the method of detecting a package containing a counterfeit or illegal product in a sorting facility around the nowadays existing sorting facilities, if any method at all, is to have a physical assistant, a human, going around the sorting facility and trying to spot packages looking suspicious and taking test samples—often of random packages. There is no specific system or systemized method to use in a sorting facility, when trying to detect potential counterfeit or illegal products early in the logistic chain, namely while sorting the packages before delivery to the end costumers.

This missing optimal method and/or system for detecting a package potentially containing counterfeit or illegal products in the sorting facility has the fatal consequence that it is extremely easy for a costumer to order a counterfeit or illegal product and have it delivered to the doorstep without consequences. Also, it is extremely easy for the producers/traders of counterfeit or illegal products to send the counterfeits or illegal products to the costumers without any consequences, since it is most unlikely that the packages containing a counterfeit or illegal product will be caught in the logistic/delivery chain—Therefore, small package delivery is today used to send fake goods directly to end-customer in a cheap, easy, fast and more or less risk-free way.

This is a huge problem for brands and for the police, since nothing stops the logistics firms from transporting illegal goods and there are thousands if not millions of counterfeit or illegal products packed in normal packages being delivered around the world every single day.

Hence, an improved method and/or system for detecting a package potentially containing a counterfeit or illegal product would be advantageous, and in particular a more efficient and/or reliable database system potentially using a virtual machine, and a counterfeit algorithm would be advantageous.

### OBJECT OF THE INVENTION

It is an object of the present invention to provide an alternative to the prior art.

In particular, it may be seen as an object of the present invention to provide a method, a computer program and/or system that solves the above mentioned problems with counterfeit and illegal products in the logistic chain.

### SUMMARY OF THE INVENTION

Thus, the above described object and several other objects are intended to be obtained in a first aspect of the invention by providing a method for detecting a package containing a counterfeit product, preferably in a package sortation facility, wherein the method comprises the steps of:
providing at least one counterfeit database comprising information of previously found counterfeit packages,
providing data of information of at least one package, preferably visible information, the information being at least one of:
   text data;
   preferably being data of the sender and/or receiver of the package such as one or more of name, company, address, postcode, phone number, and/or
   image data;
   preferably being data of one or more of stickers on the package, such as barcode or logo, delivery partner, customs declaration, shipping label, packaging material, packaging colour, physical information data, such as size or weight,
uploading and storing the provided data, preferably text and/or image, to the counterfeit database,
comparing the provided data of the package to data already stored in the counterfeit database and search for matches,
detecting exact data matches or high similarity data matches,
   if any exact matches or high similarity matches;
      determine the possibility, preferably in %, of the package being a counterfeit package by using a counterfeit comparison algorithm,
      if the counterfeit possibility is higher than a pre-determined threshold, the package is selected for further investigation,
         if further investigation results in a positive counterfeit determination, handing over the package to the responsible, preferably the Customs for possible seizure, or
         if further investigation result in a negative counterfeit determination, the package is free to proceed as normal, or
         if it is not clear whether the content of the package is being a counterfeit, communicating with the IP owners and share data of the package and then take a decision on the content of the package being counterfeit or not, or
   if none exact matches or high similarity matches, no further analysis is made.

In the context of the present invention, a ‘counterfeit database” may be understood as a database being a collection of information about previously detected counterfeit packages that is organized so that it can be easily accessed, managed and updated. However, the database might also comprise other stored data and information besides the counterfeit data. Typically, such counterfeit databases may be started, handled and/or maintained by the IP owners of the brand potentially being counterfeited.

In the context of the present invention, a ‘visible information” may be understood as anything visible on a package that can help to detect a counterfeit package. Also within the invention, ‘data’ and ‘information’ might be seen as synonyms.

In the context of the present invention, a ‘package” may be understood as anything that in some way is packed for delivery. There is no limitation of the dimensions, form, weight, packaging, and it could also be worded as a parcel, luggage, or anything similar.

In the context of the present invention, a ‘counterfeit package” may be understood as a package having a content being a counterfeit product.

In the context of the present invention, a ‘IP owners” may be understood as the owners of the brand potentially being counterfeited. It could also be called the ‘brand owners’ or the like. The IP owners could e.g. be Burberry, Channel, Hugo Boss, etc.

In the context of the present invention, a ‘Sortation facility” may be understood as a facility for sortation of packages comprising anything between a single (conveyor) belt to a big central package facility with hundreds of belts.

The invention is particularly, but not exclusively, advantageous for obtaining a systemized method, wherein the possibility of detecting a counterfeit package in the delivery chain, particularly in a sorter facility, is highly improved. This means that hundreds or even thousands of sortation centres around the world can be used to catch counterfeit packages before delivery to the end-costumer.

The invention makes this improvement possible by collecting and exploiting data from brands and logistics firms on one platform, wherein:
Brands: upload the counterfeit data they already have to the counterfeit database.
Logistics Firms: The invention establish a software layer and analyse packages at the point of sortation. This is the missing link on the open road between producers and end-customers.

This results in the invention being able to investigate counterfeit packages with an onsite facilitator and hand counterfeit over to Customs on behalf of brands. The invention furthermore has the advantages of being designed to provide the missing link in the fight against counterfeiting and of being designed to provide brands with a full control of their counterfeit goods.

The missing link provides the benefits, especially for the brand owners:
Proactive Tool: A proactive solution of software that is deployed into the logistic supply chain.
Block Road to Customer: Direct stopping mechanism for brands to influence counterfeit route in real time.
Network Effects: Brands stay in control of their data yet still benefit from network effects and be GDPR compliant.
Current Data Upload: Brands already have the data required, so the upload is efficient in terms of person-hours.
Inline with Brand Identity: No obtrusive marks or stickers distracting from the product; important to leading brands.

Logistics firms also benefit from the invention by:
Additional Revenue: Logistics firms will create additional revenues from existing hardware.
No Additional Hardware: The software can be installed onto current sorters with no intrusive changes made.
Socially Responsible: They have a growing social awareness such as DPD's Geocheck compliance.
Protects Potential Liability: The invention protect against future need to protect themselves as intermediaries under the law.
Commercial Benefit: They demonstrate that they are an active and reliable partner towards Brands

In some embodiments, the method further comprises at least one of the steps of:
standardizing text data of shipping information and making it comparable with other shipping information stored in the counterfeit database, and/or
extracting information of image data and creating a mathematical representation of the image and making it comparable with other stored data in the counterfeit database.

Specifically, such embodiments are particularly, but not exclusively, advantageous for being able to make any potential data from a package comparable to the data already stored in a counterfeit database.

In some embodiments, the method further comprises the step of reading the text of an image by Optical Character Recognition (OCR) and/or video coding. Specifically, such embodiments are particularly, but not exclusively, advantageous for providing a very effective recognition method for reading the text of an image on a package, so that the data on the package can be compared to the data stored in the counterfeit database.

In some embodiments, the method further comprises the step of analysing the image data and creating digital information of the image.

Specifically, such embodiments are particularly, but not exclusively, advantageous for providing a very effective method for reading the text of an image on a package, so that the data on the package can be compared to the data stored in the counterfeit database.

In some embodiments, the method further comprises at least one of the steps of:
making an image-to-image comparison of an image from a package and images stored in the counterfeit database, and thereby compare whether the same image data has been found on previously found counterfeit packages, and/or
making an text-to-text comparison of text data from a package and text data stored in the database, and thereby compare whether the same text data, such as sender and/or receiver information, has been found on previously found counterfeit packages.

Specifically, such embodiments are particularly, but not exclusively, advantageous for having a method, which can both use text and/or image data from a package in a delivery chain to detect if it is a potential counterfeit package. Meaning, the method is both efficient if only pictures/images of a packages is provided or if only text-data of a package is provided. However, the method is also capable of including both image-data and text-data to compare with the data already stored in the counterfeit database.

In some embodiments, the text data and/or image data of the package is provided from at least one image taking in an associated package sortation facility.

Specifically, such embodiments are particularly, but not exclusively, advantageous for being efficient even though only a single picture of a package is available to the counterfeit database and comparison algorithm.

In some embodiments, if any text data matches is detected, the method further comprises the step:
focusing on sender information by reading the shipping label using OCR and detect the sender of the package.

Specifically, such embodiments are particularly, but not exclusively, advantageous for providing an efficient method for detecting a potential counterfeit package by focusing on the information provided on the shipping label, being information, which will always be available on a package, since without a shipping label, a package will not be able to be shipped and delivered to the receiver.

Since, the information on the shipping label is easy to get access to and since it will always be on a package for delivery, the method of the invention is thereby always usable for any package, even though the only accessible information of a package is the shipping label information.

In some embodiments, if any image data matches, the method further comprises the step:
focusing on stickers, logo, barcodes and/or custom objects.

Specifically, such embodiments are particularly, but not exclusively, advantageous for being able to compare data, which is often seen on counterfeit packages and which therefore is a very efficient way to detect a match of a previously found counterfeit package.

In some embodiments, the method further comprises the step of converting addresses, such as sender and/or receiver, to geo-coordinates, so as to virtually draw a radius around the geocode location, preferably about 200-20 m radius, more preferably about 150-50 m radius, most preferably about 100 m radius. Specifically, such embodiments are particularly, but not exclusively, advantageous, since counterfeit senders usually do little changes on their addresses, and the invention should therefore not take too much attention on only one exact location.

For example: if they use ‘Park Street. No 34 . . . ’ for some packages, then they change the address to ‘Park Street. No 36 . . . ’. Even though we have the first address in the database, this is not a match (catch) for the system. Therefore, to detect such small change in e.g. the address, within the invention, the addresses are converted to geo-coordinates, and then virtually a radius around the geocode location is drawn, most preferably about a 100-meter radius. If any address is in this range, that is a suspicion.

The formula can be such as:

$$X - \vert Distance \vert = \% of possibility of being counterfeit .$$

X is pre-defined radius in meters.

|Distance| is absolute value of the distance between two coordinates in meters. Calculation can be done by using Haversine formula and then take the absolute value of it.

In some embodiments, a local counterfeit database is provided and located at an associated sortation facility, and wherein the step of comparing the provided data of the package to data already stored in the counterfeit database and search for matches and the step of detecting exact data matches or high similarity data matches is made locally using a virtual machine connected to the local database.

In the context of the present invention, a ‘virtual machine” may be understood as virtualization/emulation of a computer system wherein a comparison algorithm is deployed in the virtual machine.

Specifically, such embodiments are particularly, but not exclusively, advantageous, since sorting facilities of logistics firms is connected with the local counterfeit database by having a virtual machine in the sorter facility. The virtual machine is connected with the sorter systems in the facility. This means that the local counterfeit database, being connected to a virtual machine comprising a comparison algorithm, can work even in an off-line mode not being depending on any other databases or other information sources when calculating the possibility of a package containing a counterfeit product.

In some embodiments, a centralized counterfeit database is provided and located in a cloud and wirelessly connected to at least one associated sortation facility or to at least one local database at an associated sortation facility.

Specifically, such embodiments are particularly, but not exclusively, advantageous, since distributed computing results in a maximized performance and maximized information access.

The centralized database comprise all the data from all the potential local databases located in sorting facilities around the world, since all the local database provides new information/data to the centralized database. All the new information shared between one of the local databases and the centralized database is synchronized, preferably daily, with all the other local databases in the system.

In some embodiments, the centralized counterfeit database and the local database is wirelessly connected and wherein the databases is synchronizing (SYNC), preferably on a daily basis.

In some embodiments, the method further comprises the step of providing an online Content Management System (CMS) being connected to the counterfeit database, said CMS allowing brands to register and upload their data of known counterfeit information, said information preferably being:
counterfeit delivery information such as name, company name, address, phone number, postcode of sender and/or receiver and/or importer of package,
images of a previously caught counterfeit packages,
any identifier might be located on a package for example stickers, logos, taping and packaging material, shipping label location, package size/weight, and/or
any other relevant information on previously counterfeit.

Specifically, such embodiments are particularly, but not exclusively, advantageous by using a so called Know-Your-Costumer (KYC) Software for Logistics Firms.

Is it not required to provide all of the input types, such as text/image, for the brands, since the brands can provide only one type of input. However, the more information they provide—the more counterfeits is likely to be detected.

By partnering with Logistics Firms, the method allows the database to receive photos of packages during sortation. Then the virtual machine having a comparison algorithm deployed processes the images and compare the data that is extracted from those images with the data in the counterfeit database.

In some embodiments—when comparing text data—the comparison algorithm has the mathematical formula of:

$$\% of similarity = \frac{( number of matching characters ) * 2}{number of characters ( name 1 + name 2 )} \\ and / or \\ \% of similarity = \frac{( number of matching words ) * 2}{number of words ( address 1 + address 2 )}$$

Specifically, such embodiments are particularly, but not exclusively, advantageous for having a formula giving an outcome of a % of similarity, which is an effective and easy-to-handle outcome when detecting a potential counterfeit package.

In some embodiments, the method further comprises the step;
if any counterfeit possibility is detected by the counterfeit comparison algorithm, communicating with the associated package sortation facility and assigns a custom sorter chute for the package, said package goes to that chute automatically during sortation.

Specifically, such embodiments are particularly, but not exclusively, advantageous for providing method, wherein a detected potential counterfeit packages is sorted out from the sorting belt automatically. There is thereby no need for human interaction at the stage as everything can be done automatically.

In some embodiments, the further investigation of a package with counterfeit possibility includes conducting a visual check on the package and checking the content of the package, and
wherein the visual check is conducted by a facilitator, preferably a human facilitator, that opens the package and checks the content of the package, and wherein the steps of conducting the visual check will change depending on the brand being represented or counterfeited in the content of the package.

Specifically, such embodiments are particularly, but not exclusively, advantageous for ensuring whether or not a detected potential counterfeit package is actually containing a counterfeit product or whether the package is not a counterfeit package comprising a counterfeit product. This might however also be done be a robot or via X-ray or the like.

In the context of the present invention, a ‘facilitator” may be understood as something or someone facilitating a check of a potential counterfeit package. The facilitator can be a human, but it can also be a robot. Furthermore, it can be automated and use methods such as X-ray for checking the content of a package.

In some embodiments, the results of the comparison and/or the investigation steps of the method is applied in for machine learning to train the counterfeit comparison algorithm for future counterfeit packages detections, preferably by adjusting the weighting of the comparison algorithm using the concept of:
if the comparison algorithm makes a correct decision, the authenticity of the data used for decision making is increased, and
if comparison algorithm makes a false decision, the authenticity of the data used for decision making is decreased.

Specifically, such embodiments are particularly, but not exclusively, advantageous for recording the actions made during the method in the database and thereby have an ongoing adjustment of the weighting of counterfeit decision algorithm to constantly improve the counterfeit algorithm.

The invention further relates to a second aspect, a system for detecting a package containing a counterfeit product in an associated package sortation facility, preferably by using the method of claim 1, wherein the system comprises;
at least one counterfeit database comprising information of previously found counterfeit packages,
at least one camera or scanner mounted on an associated package sortation facility, the camera taking images of each package during sortation, said images are sent to a database and used in a counterfeit comparison algorithm,
a computer to execute the counterfeit comparison algorithm connected to the associated package sortation facility, the algorithm calculating a counterfeit possibility, preferably in %, of the package being a counterfeit package by comparison of previously detected counterfeits, and
a facility for further investigation of a package if the counterfeit possibility is higher than a pre-determined threshold and the package is selected for further investigation.

This second aspect of the invention is particularly, but not exclusively, advantageous in that the method of the invention may be implemented in a system for detecting counterfeit packages.

In a third aspect, a computer program comprising instructions which, when the program is executed by a computer, cause the computer to carry out at least the following steps of the method of claim 1:
comparing provided data of a package to data already stored in a counterfeit database and search for matches,
detecting exact data matches or high similarity data matches,
   if any exact matches or high similarity matches;
      determine the possibility, preferably in %, of the package being a counterfeit package by using a counterfeit comparison algorithm,
      if the counterfeit possibility is higher than a pre-determined threshold, the package is selected for further investigation,
   if none exact matches or high similarity matches, no further analysis is made.

This aspect of the invention is particularly, but not exclusively, advantageous in that parts of the method according to the present invention may be implemented in a computer program for detecting counterfeit packages.

In a fourth aspect, a counterfeit database system comprising:
a centralized counterfeit database and
at least one local counterfeit database, preferably a plurality of local databases, wherein the centralized database and the at least one local counterfeit database is connected wirelessly via distributed computing.

In the context of the present invention, ‘distributed computing’ may be understood as the concept in which a bigger computation process is accomplished by splitting it into multiple smaller activities and performed as diverse systems, resulting in a maximized performance.

In a fifth aspect, a method for detecting a package, containing an illegal product such as drugs or illegitimate medicine, preferably in an associated package sortation facility, wherein the method comprises the steps of:
providing at least one database for illegal packages (110, 111, 11) comprising information of previously found illegal packages,
providing data of information of at least one package, preferably visible information, the information being at least one of:
   text data;
   preferably being data of the sender and/or receiver of the package such as one or more of name, company, address, postcode, phone number, and/or
   image data;
   preferably being data of one or more of stickers on the package, such as barcode or logo, delivery partner, customs declaration, shipping label, packaging material, packaging colour, physical information data, such as size or weight,
uploading and storing the provided data, preferably text and/or image, to the database for illegal packages,
comparing the provided data of the package to data already stored in the database and search for matches,
detecting exact data matches or high similarity data matches,
   if any exact matches or high similarity matches;
      determine the possibility, preferably in %, of the package being a package containing illegal products by using a comparison algorithm,
      if the possibility of an illegal product is higher than a pre-determined threshold, the package is selected for further investigation,
         if further investigation results in a positive illegal determination, handing over the package to the responsible, preferably the Police, or
         if further investigation result in a negative illegal determination, the package is free to proceed as normal, or
         if it is not clear whether the content of the package is being a illegal product, communicating with specialist and share data of the package and then take a decision on the content of the package being counterfeit or not, or
   if none exact matches or high similarity matches, no further analysis is made.

The invention is particularly, but not exclusively, advantageous for obtaining a systemized method wherein the possibility of detecting an illegal package in the delivery chain, particularly in a sorter facility, is highly improved. This means that hundreds or even thousands of sortation centres around the world can be used to catch illegal packages before delivery to the most likely criminal end-costumers. Also, the police might get accesses to information of the sender, most likely a criminal sender.

This method has a potential of becoming a very preferably method for the police to use when catching big criminal drug deliveries.

In the context of the present invention, a ‘illegal product” may be understood as anything like unlawful drugs or medicine sold on the black market.

The first, second, third, fourth and fifth aspect of the present invention may each be combined with any of the other aspects. These and other aspects of the invention will be apparent from and elucidated with reference to the embodiments described hereinafter.

### BRIEF DESCRIPTION OF THE FIGURES

The method and system for detecting a package containing a counterfeit product according to the invention will now be described in more detail with regard to the accompanying figures. The figures show one way of implementing the present invention and is not to be construed as being limiting to other possible embodiments falling within the scope of the attached claim set.

FIG. 1 illustrates a catch flow-chart for detecting a potential counterfeit package in a sortation facility.

FIG. 2 illustrates a flow-chart of the procedure of the further investigation.

FIG. 3 illustrates the levels in the fight against counterfeiting.

Additional figures with comments are also enclosed for illustrating the invention.

### DETAILED DESCRIPTION OF AN EMBODIMENT

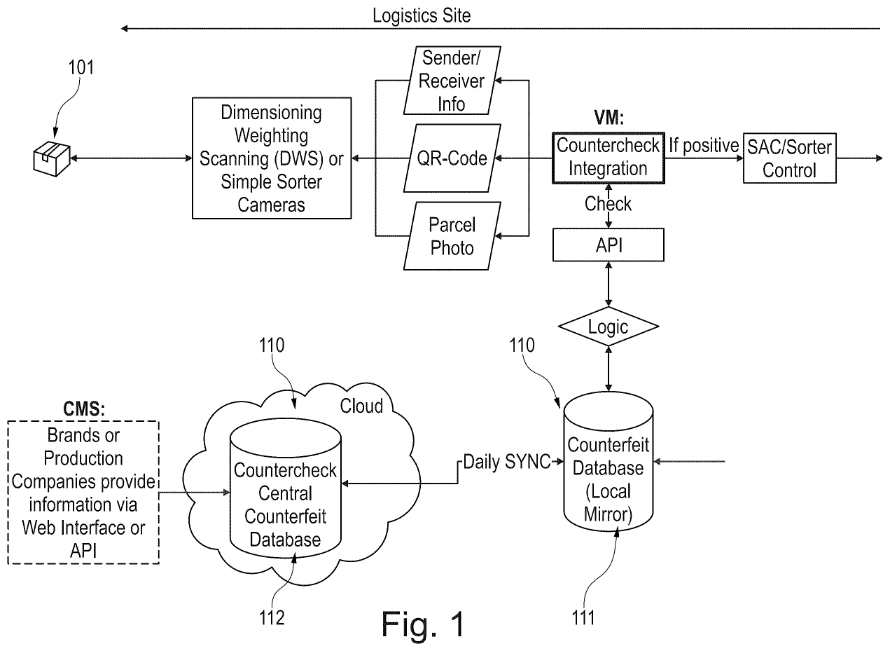

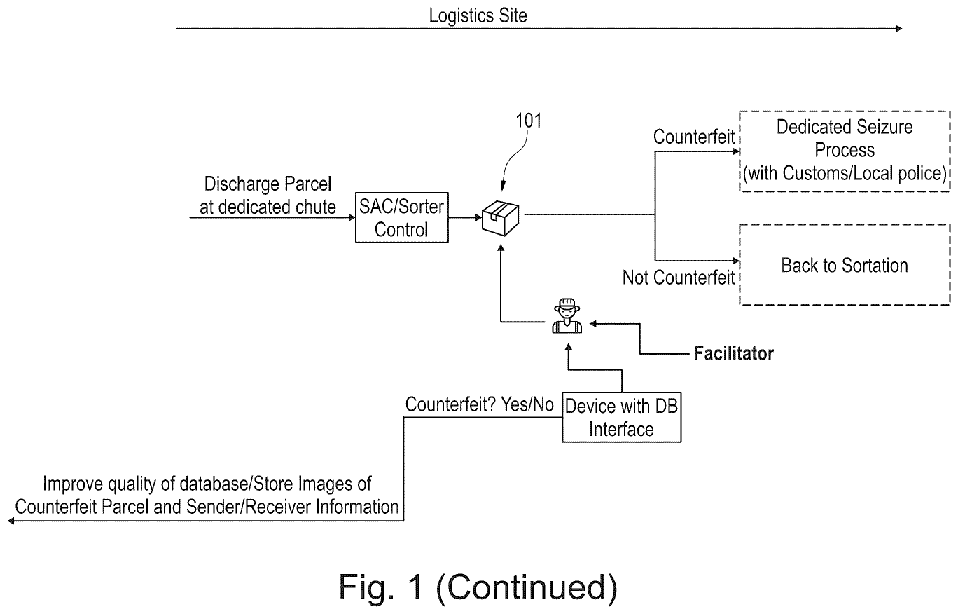

FIG. 1 illustrates a catch flow-chart of detecting a possible counterfeit package within a sorting facility conducting sorter control e.g. via Sort Allocation Computer System (SAC). A package 101 within a sorting facility is going through a scanner using a Dimnesioning-Weightning-Scanner system (DWS) and/or a camera (such as simple sorter camera) taken an image and thereby potentially providing a local counterfeit database 111 with information of the package 101. The local counterfeit database 111 comprises information of previously found counterfeit packages. The information provided is preferably data of visible information of at least one package, the information being at least one of:
text data;
preferably being data of the sender and/or receiver of the package such as one or more of name, company, address, postcode, phone number, and/or
image data;
preferably being data of one or more of stickers on the package, such as barcode or logo, delivery partner, customs declaration, shipping label, packaging material, packaging colour, physical information data, such as size/dimension or weight,

After the information is provided, the information, preferably text and/or image data, is uploaded to the local counterfeit database (111) where it is stored and later or immediately uploaded and synchronized to a central counterfeit database (112). Preferably the synchronization between the local database and the central database is done on a daily bases, or even more often. There could be only one large central counterfeit database directly connected to the sorting facilities and thereby no local database. Or, only a local database not connected to any centralized database. However, both at least one local and a centralized database connected to each other is preferred in the invention.

The local database being for security reasons if the central database is for some reason out of reach.

After the data/information of the package is uploaded to the local database 111, the provided data of the package is compared to already stored data in the counterfeit database and a search for matches is done using a virtual machine (VM) comprising a counterfeit comparison algorithm coupled to the database—This is in the figure marked with “Countercheck integration”. The virtual machine is doing the following:
detecting exact data matches or high similarity data matches,
   if any exact matches or high similarity matches;
      determine the possibility, preferably in %, of the package being a counterfeit package by using a counterfeit comparison algorithm,
      if the counterfeit possibility is higher than a pre-determined threshold, the package is selected for further investigation,
         if further investigation results in a positive counterfeit determination, handing over the package to the responsible, preferably the Customs for possible seizure, or
         if further investigation result in a negative counterfeit determination, the package is free to proceed as normal, or
         if it's not clear whether the content of the package is being a counterfeit, communicating with the brand owners and share data of the package and then take a decision on the content of the package being counterfeit or not, or
   if none exact matches or high similarity matches, no further analysis is made.

Furthermore, FIG. 1 illustrates an online Content Management System (CMS) being connected to the counterfeit database 112, said CMS allowing brands to register and upload their data of known counterfeit information, said information preferably being:
counterfeit delivery information such as name, company name, address, phone number, postcode of sender and/or receiver and/or importer of package,
images of a previously caught counterfeit packages,
any identifier might be located on a package for example stickers, logos, taping and packaging material, shipping label location, package size/weight, and/or
any other relevant information on previously counterfeit.

Also the figure illustrate, that the virtual machine (VM) communicates with the associated package sortation facility and assigns a custom sorter chute for the package, said package goes to that chute automatically during sortation if any counterfeit possibility is detected. A further investigation of a package with counterfeit possibility includes conducting a visual check on the package and checking the content of the package, and the visual check is conducted by a facilitator, that opens the package and checks the content of the package, and the steps of conducting the visual check will change depending on the brand being represented or counterfeited in the content of the package.

Moreover, the FIG. 1 illustrates a system for detecting a package containing a counterfeit product in an associated package sortation facility, preferably by using the method of claim 1, wherein the system comprises;
at least one counterfeit database comprising information of previously found counterfeit packages,
at least one camera or scanner mounted on an associated package sortation facility, the camera taking images of each package during sortation, said images are sent to a database and used in a counterfeit comparison algorithm,
a computer to execute the counterfeit comparison algorithm connected to the associated package sortation facility, the algorithm calculating a counterfeit possibility, preferably in %, of the package being a counterfeit package by comparison of previously detected counterfeits, and
a facility for further investigation of a package if the counterfeit possibility is higher than a pre-determined threshold and the package is selected for further investigation.

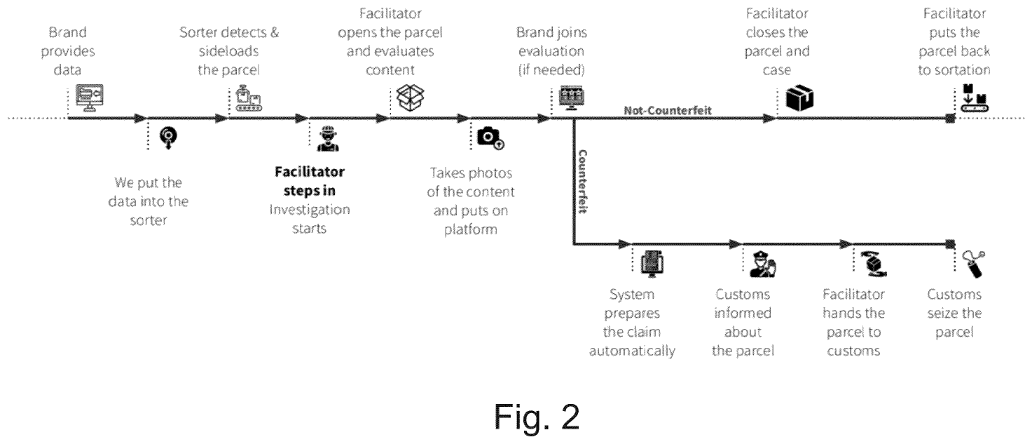

FIG. 2 illustrates a flow-chart of the procedure of the further investigation if a possible counterfeit package is detected.

When a potential counterfeit package is detected, a counterfeit comparison algorithm communicates with the associated package sortation facility and assigns a custom sorter chute for the package, said package goes to that chute automatically during sortation if any counterfeit possibility is detected.

If the counterfeit possibility is higher than a pre-determined threshold, the package is selected for further investigation,
if further investigation results in a positive counterfeit determination, handing over the package to the responsible, preferably the Customs for possible seizure, or
if further investigation result in a negative counterfeit determination, the package is free to proceed as normal, or
if it's not clear whether the content of the package is being a counterfeit, communicating with the brand owners and share data of the package and then take a decision on the content of the package being counterfeit or not.

The further investigation of a package with counterfeit possibility includes conducting a visual check on the package and checking the content of the package, and the visual check is conducted by a facilitator, that opens the package and checks the content of the package, and the steps of conducting the visual check will change depending on the brand being represented or counterfeited in the content of the package.

The results of the comparison and/or the investigation steps of the method is applied in for machine learning to train the counterfeit comparison algorithm for future counterfeit packages detections, preferably by adjusting the weighting of the comparison algorithm using the concept of:
if the comparison algorithm makes a correct decision, the authenticity of the data used for decision making is increased, and
if the comparison algorithm makes a false decision, the authenticity of the data used for decision making is decreased.

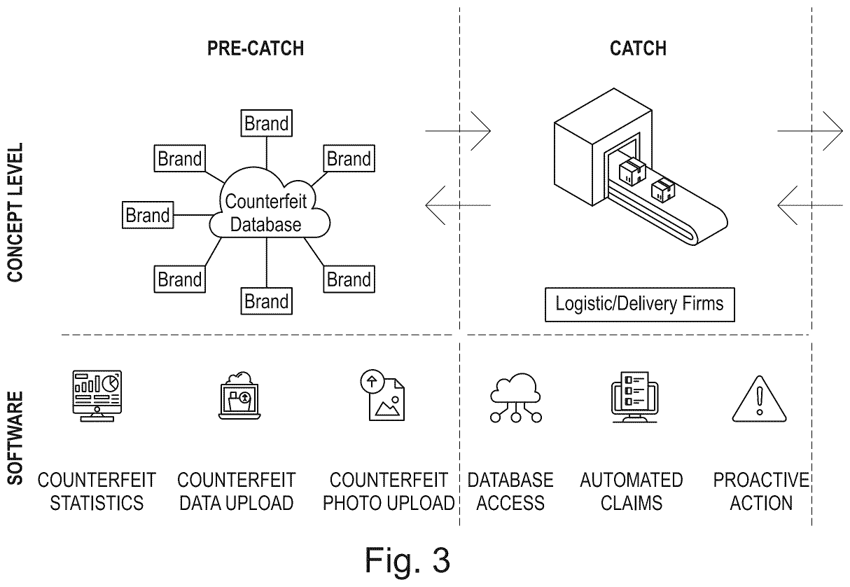

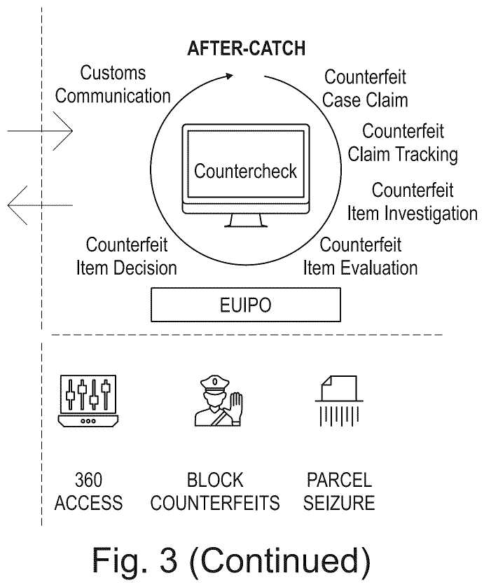

FIG. 3 illustrates the levels in the fight against counterfeiting.

In the FIG. 3, three conceptual levels are illustrated and also who will be a part of the levels and benefit from the levels is illustrated.
1. Pre-Catch→The brands providing and getting information from the counterfeit database.
2. Catch→The delivery firms will not deliver counterfeit content if the counterfeit packages is detected in the sortation before delivery.
3. After-Catch→The EUIPO is helped at ensuring the value of an intellectual property right, such as a trademark.

These are the three concept levels wherein the present invention makes a link between the levels.

Also the software of the three concept levels are illustrated.
1. Pre-Catch level:
   Counterfeit statistic
   Counterfeit Data upload
   Counterfeit Photo upload
2. Catch level:
   Database access
   Automatic claims
   Proactive action
3. After-Catch level:
   360 access
   Block counterfeits
   Package seizure

In short the invention relates to a method for detecting a package containing a counterfeit product, preferably in an associated package sortation facility, wherein the method comprises the steps of providing at least one counterfeit database comprising information of previously found counterfeit packages, providing data of information of at least one package, preferably visible information, the information being at least one of text data and/or image data, uploading and storing the provided data, preferably text and/or image, to the counterfeit database, comparing the provided data of the package to data already stored in the counterfeit database and search for matches, detecting exact data matches or high similarity data matches, if any exact matches or high similarity matches; determine the possibility, preferably in %, of the package being a counterfeit package by using a counterfeit comparison algorithm.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method for detecting a package containing a counterfeit product, preferably in an associated package sortation facility, wherein the method comprises the steps of:
providing at least one counterfeit database comprising information of previously found counterfeit packages,
providing data of information of at least one package, preferably visible information, the information being at least one of:
text data;
preferably being data of the sender and/or receiver of the package such as one or more of name, company, address, postcode, phone number, and/or
image data;
preferably being data of one or more of stickers on the package, such as barcode or logo, delivery partner, customs declaration, shipping label, packaging material, packaging colour, physical information data, such as size or weight,
uploading and storing the provided data, preferably text and/or image, to the counterfeit database,
comparing the provided data of the package to data already stored in the counterfeit database and search for matches,
detecting exact data matches or high similarity data matches,
if any exact matches or high similarity matches;
determine the possibility, preferably in %, of the package being a counterfeit package by using a counterfeit comparison algorithm,
if the counterfeit possibility is higher than a pre-determined threshold, the package is selected for further investigation,
if further investigation results in a positive counterfeit determination, handing over the package to the responsible entity, preferably the Customs for possible seizure, or
if further investigation result in a negative counterfeit determination, the package is free to proceed as normal, or
if it is not clear whether the content of the package is being a counterfeit, communicating with the IP owners and share data of the package and then take a decision on the content of the package being counterfeit or not, or
if none exact matches or high similarity matches, no further analysis is made.

2. A method according to claim 1, wherein the method further comprises at least one of the steps of:
standardizing text data of shipping information and making it comparable with other shipping information stored in the counterfeit database, and/or
extracting information of image data and creating a mathematical representation of the image and making it comparable with other stored data in the counterfeit database.

3. A method according to claim 1, wherein the method further comprises the step of reading the text of an image by Optical Character Recognition (OCR) and/or video coding.

4. A method according to claim 1, wherein the method further comprises the step of analysing the image data and creating digital information of the image.

5. A method according to claim 1, wherein the method further comprises at least one of the steps of:
making an image-to-image comparison of an image from a package and images stored in the counterfeit database, and thereby compare whether the same image data has been found on previously found counterfeit packages, and/or
making an text-to-text comparison of text data from a package and text data stored in the database, and thereby compare whether the same text data, such as sender and/or receiver information, has been found on previously found counterfeit packages.

6. A method according to claim 1, wherein the text data and/or image data of the package is provided from at least one image taking in an associated package sortation facility.

7. A method according to claim 1, wherein if any text data matches is detected, the method further comprises the step:
focusing on sender information by reading the shipping label using OCR and detect the sender of the package.

8. A method according to claim 1, wherein if any image data matches, the method further comprises the step:
focusing on stickers, logo, barcodes and/or custom objects.

9. A method according to claim 1, wherein the method further comprises the step of converting addresses, such as sender and/or receiver, to geo-coordinates, so as to virtually draw a radius around the geocode location, preferably about 200-20 m radius, more preferably about 150-50 m radius, most preferably about 100 m radius.

10. A method according to claim 1, wherein a local counterfeit database is provided and located at an associated sortation facility, and wherein the step of comparing the provided data of the package to data already stored in the counterfeit database and search for matches and the step of detecting exact data matches or high similarity data matches is made locally using a virtual machine connected to the local database.

11. A method according to claim 1, wherein a centralized counterfeit database is provided and located in a cloud and wirelessly connected to at least one associated sortation facility or to at least one local counterfeit database at an associated sortation facility.

12. A method according to claim 10, wherein the centralized counterfeit database and the local counterfeit database is connected and wherein the databases is synchronizing (SYNC), preferably on a daily basis.

13. A method according to claim 1, wherein the method further comprises the step of providing an online Content Management System (CMS) being connected to the counterfeit database, said CMS allowing brands to register and upload their data of known counterfeit information, said information preferably being:
counterfeit delivery information such as name, company name, address, phone number, postcode of sender and/or receiver and/or importer of package (101),
images of a previously caught counterfeit packages,
any identifier might be located on a package for example stickers, logos, taping and packaging material, shipping label location, package size/weight, and/or
any other relevant information on previously counterfeit.

14. A method according to claim 1, wherein—when comparing text data—the comparison algorithm has the mathematical formula of:
$$\% of similarity = \frac{( number of matching characters ) * 2}{number of characters ( name 1 + name 2 )} \\ and / or \\ \% of similarity = \frac{( number of matching words ) * 2}{number of words ( address 1 + address 2 )}$$

15. A method according to claim 1, wherein the method further comprises the step;
if any counterfeit possibility is detected by the counterfeit comparison algorithm, communicating with the associated package sortation facility and assigns a custom sorter chute for the package (101), said package goes to that chute automatically during sortation.

16. A method according to claim 1, wherein the further investigation of a package with counterfeit possibility includes conducting a visual check on the package and checking the content of the package, and
wherein the visual check is conducted by a facilitator, preferably a human facilitator, that opens the package and checks the content of the package, and
wherein the steps of conducting the visual check will change depending on the brand being represented or counterfeited in the content of the package.

17. A method according to claim 1, wherein the results of the comparison and/or the investigation steps of the method is applied in for machine learning to train the counterfeit comparison algorithm for future counterfeit packages detections, preferably by adjusting the weighting of the comparison algorithm using the concept of:
if the comparison algorithm makes a correct decision, the authenticity of the data used for decision making is increased, and
if comparison algorithm makes a false decision, the authenticity of the data used for decision making is decreased.

18. A system for detecting a package containing a counterfeit product in an associated package sortation facility, preferably by using the method of claim 1, wherein the system comprises;
at least one counterfeit database comprising information of previously found counterfeit packages,
at least one camera or scanner mounted in, or on, an associated package sortation facility, the camera taking images of each package during sortation, said images are sent to a database and used in a counterfeit comparison algorithm,
a computer to execute the counterfeit comparison algorithm connected to the associated package sortation facility, the algorithm calculating a counterfeit possibility, preferably in %, of the package being a counterfeit package by comparison of previously detected counterfeits, and
a facility for further investigation of a package if the counterfeit possibility is higher than a pre-determined threshold and the package is selected for further investigation.

19. A counterfeit database system for implementing the method of claim 1, comprising:
a centralized counterfeit database and
at least one local counterfeit database, preferably a plurality of local databases,
wherein the centralized database and the at least one local counterfeit database is connected via distributed computing.

20. A computer program comprising instructions which, when the program is executed by a computer, cause the computer to carry out at least the following steps of the method of claim 1:
comparing provided data of a package to data already stored in a counterfeit database and search for matches, and
detecting exact data matches or high similarity data matches,
if any exact matches or high similarity matches;
determine the possibility, preferably in %, of the package being a counterfeit package by using a counterfeit comparison algorithm,
if the counterfeit possibility is higher than a pre-determined threshold, the package is selected for further investigation,
if none exact matches or high similarity matches, no further analysis is made.

21. A method for detecting a package, containing an illegal product, such as drugs or illegitimate medicine, preferably in an associated package sortation facility, wherein the method comprises the steps of:
providing at least one database for illegal packages comprising information of previously found illegal packages,
providing data of information of at least one package, preferably visible information, the information being at least one of:
text data;
preferably being data of the sender and/or receiver of the package such as one or more of name, company, address, postcode, phone number, and/or
image data;
preferably being data of one or more of stickers on the package, such as barcode or logo, delivery partner, customs declaration, shipping label, packaging material, packaging colour, physical information data, such as size or weight,
uploading and storing the provided data, preferably text and/or image, to the database for illegal packages,
comparing the provided data of the package to data already stored in the database and search for matches,
detecting exact data matches or high similarity data matches,
if any exact matches or high similarity matches;
determine the possibility, preferably in %, of the package being a package containing illegal products by using a comparison algorithm,
if the possibility of an illegal product is higher than a pre-determined threshold, the package is selected for further investigation,
if further investigation results in a positive illegal determination, handing over the package to the responsible entity, preferably the Customs and/or the Police, or
if further investigation result in a negative illegal determination, the package is free to proceed as normal, or
if it is not clear whether the content of the package is being a illegal product, communicating with a specialist, preferably from the Customs and/or the Police, and share data of the package and then take a decision on the content of the package being counterfeit or not, or
if none exact matches or high similarity matches, no further analysis is made.
